(19) United States
(12) Patent Application Publication
(10) Pub. No.: US 2026/0094869 A1
(43) Pub. Date: Apr. 2, 2026

(54) ELECTROLYTE SOLUTION FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Seunghyeon SON, Yongin-si (KR); TAE HYON BAE, Yongin-si (KR); Harim LEE, Yongin-si (KR); Sanghyung KIM, Yongin-si (KR); Sangheon LEE, Yongin-si (KR); SUNDAE KIM, Yongin-si (KR); Yeji YANG, Yongin-si (KR); CHEONSOO KIM, Yongin-si (KR)

(21) Appl. No.: 19/212,124

(22) Filed: May 19, 2025

(30) Foreign Application Priority Data
Oct. 2, 2024 (KR) 10-2024-0133966

(51) Int. Cl. H01M 10/0567; H01M 4/525; H01M 10/04; H01M 10/052; H01M 10/0568; H01M 10/0569

(52) U.S. Cl. CPC H01M 10/0567; H01M 4/525; H01M 10/0427; H01M 10/052; H01M 10/0568; H01M 10/0569; H01M 2300/004

(57) ABSTRACT

An electrolyte solution for a rechargeable lithium battery and a rechargeable lithium battery including the same are provided. The electrolyte solution for the rechargeable lithium battery includes a non-aqueous organic solvent, a lithium salt, and additives including first to third additives.

### CROSS-REFERENCE TO RELATED APPLICATION

This application claims priority to and the benefit of Korean Patent Application No. 10-2024-0133966, filed on Oct. 2, 2024, in the Korean Intellectual Property Office, the entire content of which is incorporated herein by reference.

### BACKGROUND

### 1. Field

The present disclosure relates to an electrolyte solution for a rechargeable lithium battery and a rechargeable lithium battery including the same.

### 2. Background

Recently, with the rapid proliferation of battery-powered electronic and/or electric devices, such as mobile phones, laptop computers, electric vehicles, and/or the like, there has been significant increase in the demand for batteries, e.g., rechargeable batteries, with relatively high energy density and high capacity. Accordingly, extensive research efforts are directed towards enhancing or improving the performance of such rechargeable batteries, including rechargeable lithium batteries.

Rechargeable lithium batteries include a positive electrode and a negative electrode, each including an active material that allows the intercalation and deintercalation of lithium ions, and an electrolyte solution. A rechargeable lithium battery produces or generates electrical energy from redox reactions that occur as lithium ions are intercalated into or deintercalated from the positive electrode and the negative electrode.

For example, a lithium salt dissolved in a non-aqueous organic solvent may be used as an electrolyte for rechargeable lithium batteries. The performance and operating characteristics of these rechargeable lithium batteries arise as a result from complex reactions between the positive electrode and the electrolyte and/or between the negative electrode and the electrolyte. Thus, the use of an appropriate or suitable electrolyte may be a critical variable for enhancing or improving the performance of the rechargeable lithium batteries.

### SUMMARY

One or more aspects of the present disclosure are directed toward an electrolyte solution for a rechargeable lithium battery having suitable or superior performance, e.g., at high voltages. For example, the electrolyte solution may exhibit enhanced performance, even at high voltages.

One or more aspects of the present disclosure are directed toward a rechargeable lithium battery including the electrolyte solution.

Additional aspects will be set forth in part in the description which follows and, in part, will be apparent from the description, or may be learned by practice of the presented embodiments of the disclosure.

According to one or more embodiments of the present disclosure, an electrolyte solution for a rechargeable lithium battery includes a non-aqueous organic solvent, a lithium salt, a first additive represented by Formula 1, a second additive represented by Formula 2, and a third additive represented by Formula 3.

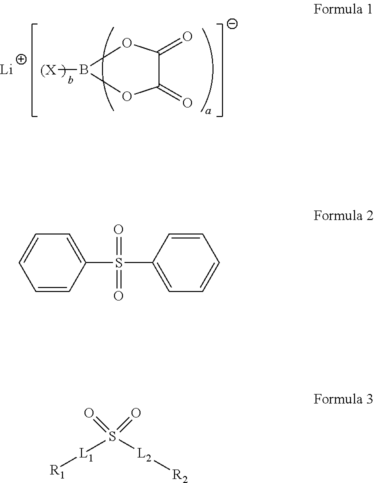

In Formulas 1 to 3,
X may be a halogen group or a C1 to C10 haloalkyl group,
a may be 1 or 2,
when (e.g., if) a is 1, b may be 2,
when (e.g., if) a is 2, b may be 0,
L₁ and L₂ may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group,
R₁ and R₂ may each independently be a substituted or unsubstituted C1 to C20 alkyl group, a substituted or unsubstituted C6 to C20 aryl group, or a substituted or unsubstituted C2 to C20 heteroaryl group, and
at least one of R₁ or R₂ may be a group represented by Formula A,

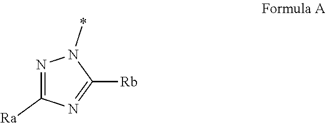

in Formula A,
Rₐ and R_{b} may each independently be hydrogen, a halogen group, a substituted or unsubstituted C1 to C10 alkyl group, or a substituted or unsubstituted C3 to C10 cycloalkyl group.

In one or more embodiments of disclosure, a rechargeable lithium battery includes a positive electrode including a positive electrode active material, a negative electrode including a negative electrode active material, and the electrolyte solution for a rechargeable lithium battery described herein.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain principles of the present disclosure. In the drawings:

FIG. 1 is a simplified conceptual view showing a rechargeable lithium battery according to one or more embodiments of disclosure; and

FIGS. 2-5 are schematic views each showing a rechargeable lithium battery according to one or more embodiments, e.g., FIG. 2 shows a cylindrical battery, FIG. 3 shows a prismatic battery, and FIGS. 4 and 5 each show a pouch-type (kind) battery.

### DETAILED DESCRIPTION

In order to sufficiently understand the configuration and effects of the present disclosure, embodiments of the present disclosure will be described with reference to the accompanying drawings. It should be noted, however, that the present disclosure is not limited to the following example embodiments, and may be implemented in one or more suitable forms and modified. Rather, the embodiments herein are provided so that present invention will be thorough and complete and will fully convey the scope of disclosure to those skilled in the art.

Herein, it will be understood that if (e.g., when) a component is referred to as being on another component, the component may be directly on another component, or an intervening third component may be present. In some embodiments, in the drawings, thicknesses of components are exaggerated for effectively describing technical contents. Like reference numerals refer to like elements throughout, and duplicative descriptions thereof may not be provided.

Unless otherwise specified herein, the expression of a singular form may include the expression of the plural form. In some embodiments, unless otherwise specified, the phrase “A or B” may indicate “A but not B”, “B but not A”, or “A and B”. The terms “comprises,” “comprise,” “includes,” “include,” “comprising,” “including,” “have,” “having,” and/or “has,” as used herein are intended to designate the presence of an embodied aspect, step (e.g., act or task), component, and/or a (e.g., any suitable) combination thereof. However, the use of these terms does not exclude the presence or addition of one or more other aspects, steps (e.g., acts or tasks), and components. Additionally, the terms “comprise(s)/comprising,” “include(s)/including,” “have/has/having”, or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof. Moreover, in this context, “consisting essentially of” indicates that any additional components will not materially affect the chemical, physical, or electrical properties of the electrolyte solution and/or rechargeable lithium battery.

As used herein, the term “combination thereof” may refer to a mixture, a stack, a composite, a copolymer, an alloy, a blend, or a reaction product.

In one or more embodiments, the term “layer” herein includes not only a shape formed or provided on the whole surface if (e.g., when) viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In the context of the present application and unless otherwise defined, the terms “use,” “using,” and “used” may be considered synonymous with the terms “utilize,” or “utilization,” “utilizing,” and “utilized,” respectively.

Herein, unless otherwise defined, “substitution” may indicate that at least one hydrogen in a substituent or compound is substituted with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, and/or a (e.g., any suitable) combination thereof.

For example, the “substitution” may indicate that at least one hydrogen in a substituent or compound is substituted with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the “substitution” may indicate that at least one hydrogen in a substituent or compound is substituted with deuterium, a halogen group, a C1 to C20 alkyl group, a C6 to C30 aryl group, a C1 to C10 fluoroalkyl group, or a cyano group. In some embodiments, the “substitution” may indicate that at least one hydrogen in a substituent or compound is substituted with deuterium, a halogen group, a C1 to C5 alkyl group, a C6 to C18 aryl group, a C1 to C5 fluoroalkyl group, or a cyano group. For example, the “substitution” may indicate that at least one hydrogen in a substituent or compound is substituted with deuterium, a cyano group, a halogen group, a methyl group, an ethyl group, a propyl group, a butyl group, a phenyl group, a biphenyl group, a terphenyl group, a trifluoromethyl group, or a naphthyl group.

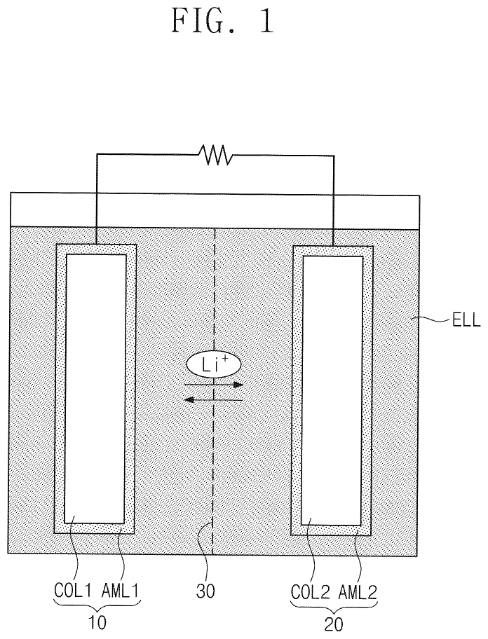

FIG. 1 is a simplified conceptual view showing a rechargeable lithium battery according to one or more embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced and/or apart (e.g., spaced apart or separated) from each other by the separator 30. The separator 30 may be arranged between the positive electrode 10 and the negative electrode 20. The positive electrode 10, the negative electrode 20 and the separator 30 may be in contact with the electrolyte solution ELL. The positive electrode 10, the negative electrode 20 and the separator 30 may be impregnated in the electrolyte solution ELL.

The electrolyte solution ELL may be a medium for transferring lithium ions between the positive electrode 10 and the negative electrode 20. In the electrolyte solution ELL, the lithium ions may move through the separator 30 toward the positive electrode 10 or the negative electrode 20.

### Electrolyte Solution for Rechargeable Lithium Battery

An electrolyte solution for a rechargeable lithium battery includes a non-aqueous organic solvent, a lithium salt, a first additive represented by Formula 1, a second additive represented by Formula 2, and a third additive represented by Formula 3.

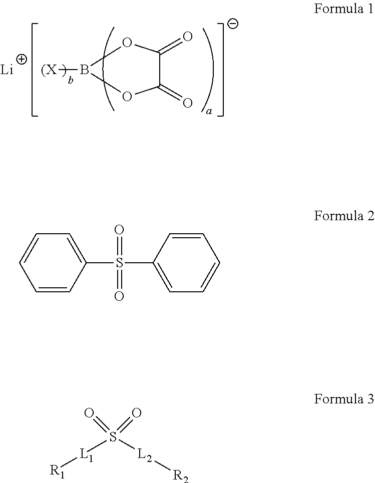

In Formulas 1 to 3,
X may be a halogen group or a C1 to C10 haloalkyl group,
a may be 1 or 2,
if (e.g., when) a is 1, b may be 2,
if (e.g., when) a is 2, b may be 0,
L₁ and L₂ may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group,
R₁ and R₂ may each independently be a substituted or unsubstituted C1 to C20 alkyl group, a substituted or unsubstituted C6 to C20 aryl group, or a substituted or unsubstituted C2 to C20 heteroaryl group, and
at least one of R₁ or R₂ may be a group represented by Formula A,

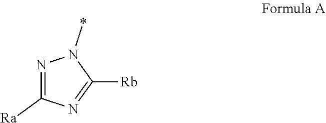

in Formula A,
Rₐ and R_{b} may each independently be hydrogen, a halogen group, a substituted or unsubstituted C1 to C10 alkyl group, or a substituted or unsubstituted C3 to C10 cycloalkyl group.

The non-aqueous organic solvent may serve as a medium for transmitting ions taking part in the electrochemical reaction of a battery.

The non-aqueous organic solvent may be a carbonate-based, ester-based, ether-based, ketone-based, or alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, or tetrahydrofuran. The ketone-based solvent may include cyclohexanone. The alcohol-based solvent may include ethyl alcohol or isopropyl alcohol, and the aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1,4-dioxolane; or sulfolanes.

In some embodiments, if (e.g., when) a carbonate-based solvent is used as the non-aqueous organic solvent, cyclic carbonate and linear carbonate may be mixed and used, and the cyclic carbonate and the linear carbonate may be mixed in a volume ratio of about 1:1 to about 1:9.

For example, the non-aqueous organic solvent may include at least one selected from among ethylene carbonate (EC), propylene carbonate (PC), propyl propionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

As a non-limiting example, the non-aqueous organic solvent may be a mixed solvent of ethylene carbonate (EC), propylene carbonate (PC), and propylpropionate (PP).

For example, the ethylene carbonate (EC) may be included in an amount of about 5 vol % to about 30 vol % or about 10 vol % to about 20 vol % with respect to a total amount of the non-aqueous organic solvent. The propylene carbonate (PC) may be included in an amount of about 10 vol % to about 30 vol % or about 10 vol % to about 25 vol % with respect to a total amount of the non-aqueous organic solvent. The propylpropionate (PP) may be included in an amount of about 50 vol % to about 90 vol % or about 65 vol % to about 85 vol %.

The ethylene carbonate (EC), the propylene carbonate (PC), and the propylpropionate (PP) may be provided in a volume ratio of 1:a:b. In this case, a represents an amount of propylene carbonate (PC) and may range from about 0.5 to about 3 or about 1 to about 2, and b represents an amount of propylpropionate (PP) and may range from about 2 to about 10 or about 5 to about 10.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluoro(oxalato)borate(LiDFOB), lithium difluorobis(oxalato)phosphate (LiDFBOP), and lithium bis(oxalato) borate (LiBOB).

As a non-limiting example, the lithium salt may include at least one (e.g., one or more) of LiPF₆, LiClO₄, LiBF₄, lithium bis(fluorosulfonyl)imide (LiFSI), LiTFSI, LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LiN(SO₃C₂F₅)₂, Li(FSO₂)₂N, and/or LiC₄F₉SO₃. For example, the lithium salt may include LiPF₆.

The lithium salt may have a concentration of about 0.1 molarity (M) to about 2.0 M. For example, the lithium salt may have a concentration of about 0.5 M to about 1.0 M, equal to or less than about 2.0 M, equal to or less than about 1.7 M, or equal to or less than about 1.5 M. As the concentration of the lithium salt falls within the described ranges, the electrolyte may appropriately or suitably maintain its conductivity and viscosity.

Rechargeable lithium batteries may be prepared for use by injecting an electrolyte solution into a battery cell that includes a positive electrode containing a positive electrode active material capable of intercalating and deintercalating lithium, and a negative electrode containing a negative electrode active material capable of intercalating and deintercalating lithium. In the process of charging a cell, particularly during rapid charging of cells with a high-density electrode plate, lithium ions may fail to intercalate into an active material from the negative electrode plate inside the cell and instead reduce on a surface of the negative electrode, and thus be deposited as lithium crystals having a tree-like (e.g., dendritic) structure, leading to the formation of lithium dendrites. For example, lithium, which shuttles between the positive electrode and the negative electrode through a liquid electrolyte, is highly reactive and may react with the electrolyte upon contact, resulting in the formation of a solid electrolyte interphase (SEI) as a lithium layer on the surface of the negative or positive electrode. With continued battery use, the SEI layer may non-uniformly (e.g., substantially non-uniformly) grow in thickness due to variations in lithium ion transport, eventually resulting in the formation of crystal dendrites.

The growth of crystals in the lithium dendrites may damage a separator, leading to internal short circuits or degradation, thereby reducing battery performance and safety. Accordingly, methods of artificially forming a substantially uniform SEI on the surface of the negative or positive electrode, (e.g., before electrolyte contact) to prevent or reduce the formation of lithium dendrites attributed to the SEI having a non-substantially uniform thickness, and adding a low-viscosity ester-based solvent to suppress or reduce the formation of lithium dendrites have been attempted. However, the ester-based solvents have poor oxidation resistance, which may cause cell degradation at high voltages such as at least about 4.0 V (e.g., or greater). Therefore, research continues into methods to effectively suppress or reduce the formation of lithium dendrites even at high voltages.

The electrolyte solution for a rechargeable lithium battery according to one or more embodiments includes three additives, (e.g., the first to third additives represented by Formulas 1 to 3) in combination. A rechargeable lithium battery including the electrolyte solution may thus exhibit superior lifespan characteristics and stability even under high voltage, quick charging, and high temperature conditions if (e.g., when) a rechargeable lithium battery including the electrolyte solution is activated.

For example, the inclusion of the electrolyte for a rechargeable lithium battery according to one or more embodiments may effectively suppress or reduce positive electrode degradation that may be induced under repeated charge/discharge and/or high voltage conditions and lithium dendrite formation that may be induced in a high-density electrode plate. In some embodiments, the inclusion of the electrolyte may further improve high-temperature storage characteristics, effectively suppress or reduce an increase in internal battery resistance and gas generation, and improve the cycle lifespan characteristics of batteries (e.g., rechargeable lithium batteries).

For example, the first additive according to one or more embodiments may form a film exhibiting low surface resistance and superior thermal stability, thereby effectively suppressing or reducing electrolyte decomposition reactions.

The first additive may be a borate-based lithium salt compound. For example, the first additive may include lithium bis(oxalato)borate (LiBOB), lithium difluoro(oxalato)borate (LiDFOB), and/or a (e.g., any suitable) combination thereof. As a non-limiting example, the first additive may be at least one selected from among lithium bis(oxalato)borate (LiBOB) and lithium difluoro(oxalato)borate (LiDFOB).

The lithium bis(oxalato)borate (LiBOB) may be electrochemically decomposed at positive and negative electrode interfaces to form a stable borate-based (B—O) film. In some embodiments, the lithium difluoro(oxalato)borate (LiDFOB) has a halogen element such as fluorine, and may thus form a strong film composed of LiF and borate-based (B—O) organic materials generated during charge/discharge on the positive and negative electrodes.

According to one or more embodiments, the first additive is represented by Formula 1.

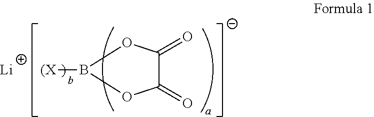

In Formula 1,
X may be a halogen group or a C1 to C10 haloalkyl group, a may be 1 or 2, if (e.g., when) a is 1, b may be 2, and if (e.g., when) a is 2, b may be 0.

For example, X may be F, Br, Cl, or I, and as a non-limiting example, X may be F or Cl.

The first additive may be represented by Formula 1-1 or Formula 1-2.

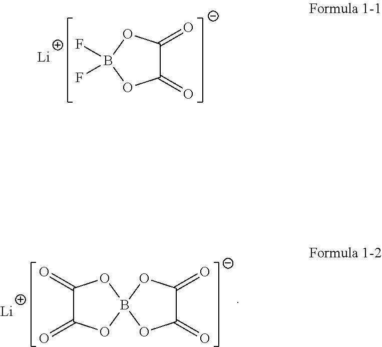

The first additive may be provided in an amount of about 0.1 wt % to about 5 wt % with respect to a total weight of the electrolyte solution for a rechargeable lithium battery. For example, the first additive may be provided in an amount of about 0.2 wt % to about 3.5 wt %, about 0.3 wt % to about 2.5 wt %, about 0.5 wt % to about 2 wt %, or about 1 wt % to about 1.5 wt %.

When the amount of the first additive satisfies the described ranges, batteries (e.g., rechargeable lithium batteries) may have further improved cycle characteristics and lifespan characteristics. When the amount of the first additive is less than the described ranges, a film may not be fully formed on the positive or negative electrode, and if (e.g., when) the amount of the first additive is greater than the described ranges, batteries (e.g., rechargeable lithium batteries) may have reduced capacity and lifespan characteristics resulting from increased resistance of the positive and negative electrodes.

In some embodiments, the second additive may effectively form a film on the positive electrode active material, thereby enabling the rechargeable lithium battery to achieve improvement in battery characteristics, particularly capacity retention at high voltages. In some embodiments, the film formed on the surface of the positive electrode may serve as a protective film capable of blocking an active site on the surface of the positive electrode, and/or may thus prevent or reduce a portion of transition metals from being eluted and deposited on the negative electrode during charge/discharge. Said protective film may also mitigate degradation of the positive electrode, and effectively suppress or reduce side reactions and/or gas generation that may be caused between an electrolyte and the positive electrode, resulting in improved performance and mitigated overcharge characteristics at high temperatures.

According to one or more embodiments, the second additive is represented by Formula 2.

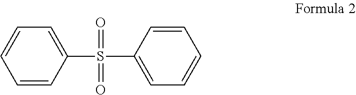 [SMILES: O=S(=O)(c1ccccc1)c1ccccc1]

The second additive may be provided in an amount of about 0.1 wt % to about 5 wt % with respect to a total weight of the electrolyte solution for a rechargeable lithium battery. For example, the second additive may be provided in an amount of about 0.2 wt % to about 4 wt %, about 0.3 wt % to about 3.5 wt %, or about 0.5 wt % to about 2 wt %, with respect to a total weight of the electrolyte solution for a rechargeable lithium battery. When the amount of the second additive satisfies the described ranges, the effect of preventing or reducing degradation at the positive electrode may be further improved.

In some embodiments, the third additive, may have a halogen component, such as fluorine, in a suitable structure, and may more easily form a strong film (e.g., protective film) on the positive and negative electrodes during repeated charging/discharging. Accordingly, the rechargeable lithium battery may have improved cycle lifespan characteristics, particularly further improved lifespan characteristics and stability at high temperatures.

According to one or more embodiments, the third additive is represented by Formula 3.

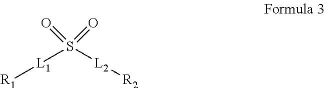

In Formula 3,
L₁ and L₂ may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group, R₁ and R₂ may each independently be a substituted or unsubstituted C1 to C20 alkyl group, a substituted or unsubstituted C6 to C20 aryl group, or a substituted or unsubstituted C2 to C20 heteroaryl group, and at least one of R₁ or R₂ may be a group represented by Formula A,

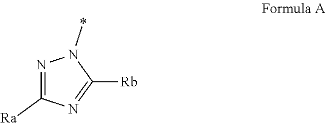

in Formula A,
Rₐ and R_{b} may each independently be hydrogen, a halogen group, a substituted or unsubstituted C1 to C10 alkyl group, or a substituted or unsubstituted C3 to C10 cycloalkyl group.

As a non-limiting example, at least one of L₁ or L₂ may be a substituted or unsubstituted C1 to C5 alkylene group.

As a non-limiting example, L₁ and L₂ may each independently be a substituted or unsubstituted C1 to C5 alkylene group.

As a non-limiting example, at least one of L₁ or L₂ may be a substituted or unsubstituted C2 to C5 alkylene group.

As a non-limiting example, L₁ and L₂ may each independently be a substituted or unsubstituted C2 to C5 alkylene group.

As a non-limiting example, L₁ and L₂ may be the same and may be an unsubstituted C2 to C5 alkylene group.

In some embodiments, as a non-limiting example, R₁ and R₂ may each independently be a substituted or unsubstituted C6 to C10 aryl group, or a substituted or unsubstituted C2 to C10 heteroaryl group.

As a non-limiting example, R₁ and R₂ may be the same and may be a substituted or unsubstituted C2 to C10 heteroaryl group.

In some embodiments, at least one of R₁ or R₂ may be a group represented by Formula A.

As a non-limiting example, R₁ and R₂ may be the same and R₁ and R₂ may both (e.g., simultaneously) be groups represented by Formula A.

In some embodiments, Rₐ and R_{b} may each independently be hydrogen, a halogen group, a substituted or unsubstituted C1 to C5 alkyl group, or a substituted or unsubstituted C3 to C5 cycloalkyl group.

As a non-limiting example, Rₐ and R_{b} may be the same and may be hydrogen.

In some embodiments, the third additive may be represented by Formula 3-1.

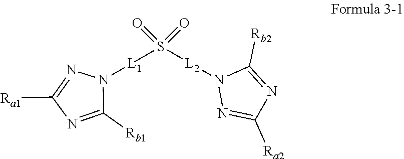

In Formula 3-1,
L₁ and L₂ may each independently be a substituted or unsubstituted C2 to C5 alkylene group, and
Rₐ₁, R_{b1}, Rₐ₂, and R_{b2} may each independently be hydrogen, a halogen group, a substituted or unsubstituted C1 to C10 alkyl group, or a substituted or unsubstituted C3 to C10 cycloalkyl group.

As a non-limiting example, Rₐ₁, R_{b1}, Rₐ₂, and R_{b2} may each independently be hydrogen, a halogen group, a substituted or unsubstituted C1 to C5 alkyl group, or a substituted or unsubstituted C3 to C5 cycloalkyl group.

As a non-limiting example, Rₐ₁, R_{b1}, Rₐ₂, and R_{b2} may each (e.g., all) be the same and may be hydrogen.

In some embodiments, the third additive may be represented by Formula 3-1-1 or Formula 3-1-2.

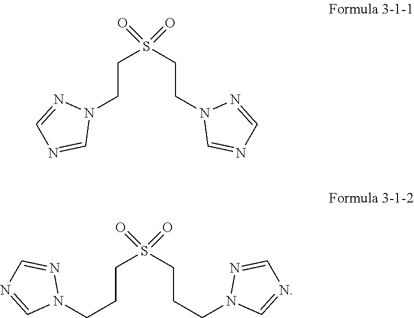 [SMILES: O=S(=O)(CCn1cncn1)CCn1cncn1 ; O=S(=O)(CCCn1cncn1)CCCn1cncn1]

The third additive may be provided in an amount of about 0.1 wt % to about 5 wt % with respect to a total weight of the electrolyte solution for a rechargeable lithium battery. For example, the third additive may be provided in an amount of about 0.2 wt % to about 4 wt %, about 0.3 wt % to about 3.5 wt %, or about 0.5 wt % to about 2 wt %, with respect to a total weight of the electrolyte solution for a rechargeable lithium battery. When the amount of the third additive satisfies the described ranges, an increase in resistance at high temperatures may be prevented or reduced, thereby further improving lifespan characteristics and output characteristics.

The first additive, the second additive, and the third additive may be provided in a weight ratio of 1:w₁:w₂. In this case, w₁ represents an amount of the second additive and may range from about 0.25 to about 4, and w₂ represents an amount of the third additive and may range from about 0.25 to about 4. For example, w₁ may range from about 0.25 to about 3, about 0.3 to about 2.5, or about 0.5 to about 2, and w₂ may range from about 0.25 to about 3, about 0.4 to about 2.5, or about 0.5 to about 2.

For example, the second additive and the third additive may be provided in a weight ratio (w₁:w₂) of about 1:4 to about 4:1. For example, the second additive and the third additive may be provided in a weight ratio (w₁:w₂) of about 1:4 to about 3:1, about 1:2 to about 2:1, or about 1:1 to about 2:1.

One or more embodiments provide a rechargeable lithium battery having superior lifespan characteristics and stability under high voltage and quick charging conditions, and superior lifespan characteristics and stability under high temperature conditions. In one or more embodiments, this may be achieved by employing suitable compounds as the first, second, and third additives, while controlling the content (e.g., amount) and weight ratio of each component. Accordingly, the electrolyte solution for a rechargeable lithium battery according to one or more embodiments includes the first to third additives represented by Formulas 1 to 3 in combination, and has the content (e.g., amount) and weight ratio of the first to third additives controlled or selected within a suitable range. Accordingly, the electrolyte solution may thus maximize or increase lifespan characteristics and stability under high voltage, quick charging, and high temperature conditions if (e.g., when) a rechargeable lithium battery including the electrolyte solution is activated.

For example, the present disclosure describes an electrolyte solution for rechargeable lithium batteries that includes various additives to enhance performance. The first additive, a borate-based lithium salt compound such as lithium bis(oxalato)borate (LiBOB) and/or lithium difluoro(oxalato)borate (LiDFOB), forms a film with low surface resistance and superior thermal stability, effectively reducing electrolyte decomposition reactions. This additive is provided in specific weight percentages to enhance battery cycle characteristics and lifespan. The second additive forms a protective film on the positive electrode, improving battery characteristics, particularly capacity retention at high voltages. This film prevents the elution and deposition of transition metals on the negative electrode, mitigating degradation and side reactions, and enhancing performance at high temperatures. The second additive is also provided in specific weight percentages to enhance its effectiveness. The third additive, which may contain a halogen component like fluorine, forms a strong protective film on both electrodes during repeated charging and discharging. This improves the battery's cycle lifespan and stability, especially at high temperatures. The third additive is included in the electrolyte solution in controlled amounts to prevent or reduce increased resistance and ensure enhance performance. Overall, the electrolyte solution combines the first, second, and third additives in specific weight ratios to enhance the lifespan and stability of rechargeable lithium batteries under high voltage, quick charging, and high temperature conditions. This careful selection and control of additives ensure superior battery performance and longevity.

In some embodiments, the electrolyte solution according to one or more embodiments may include the first to third additives in combination may exhibit superior lifespan characteristics and improved stability if (e.g., when) a rechargeable lithium battery including the electrolyte solution is charged at a high voltage of about 4.0 V or greater and a rapid charge of about 3 C or greater. For example, the high voltage may be about 4.0 V or greater, about 4.4 V or greater, about 4.5 V or greater, or about 4.53 V or greater. For example, the rechargeable can have a driving voltage of at least about 4.0 V.

### Rechargeable Lithium Battery

A rechargeable lithium battery according to one or more embodiments includes a positive electrode including a positive electrode active material, a negative electrode including a negative electrode active material, and the electrolyte solution for a rechargeable lithium battery as described herein.

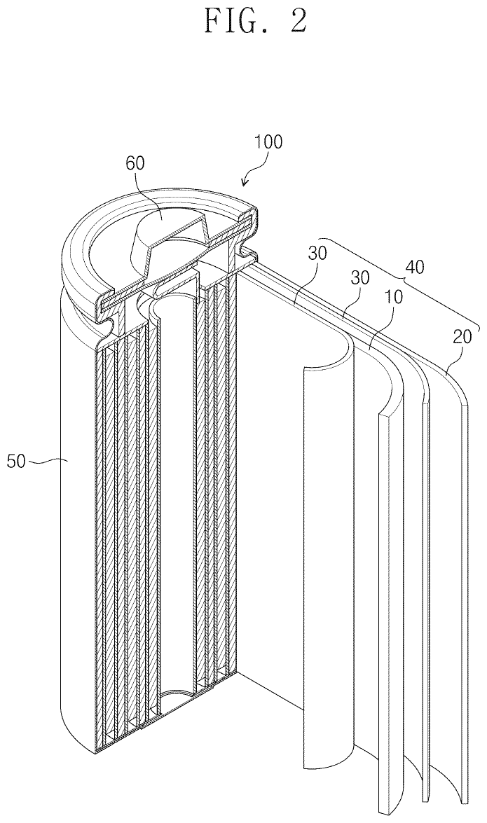

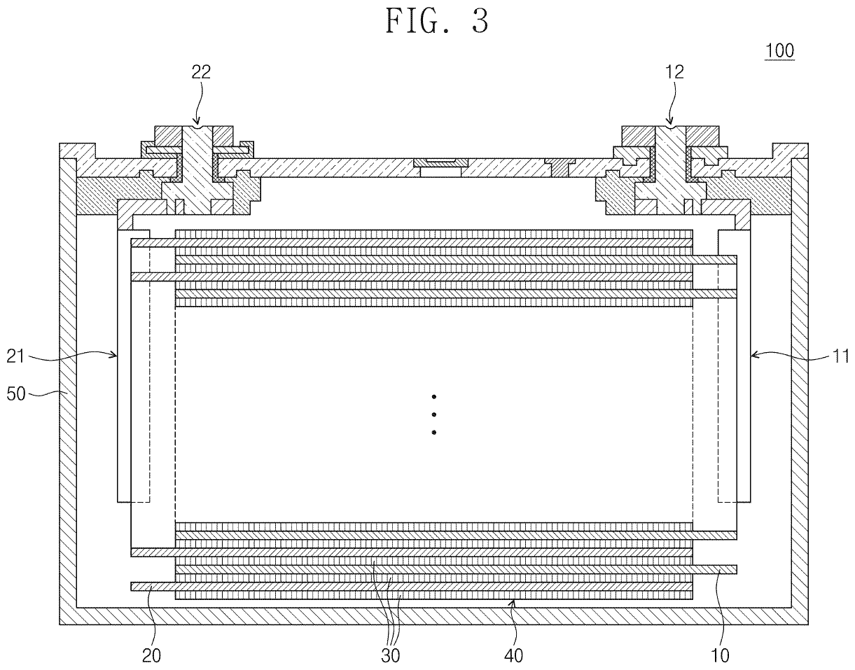

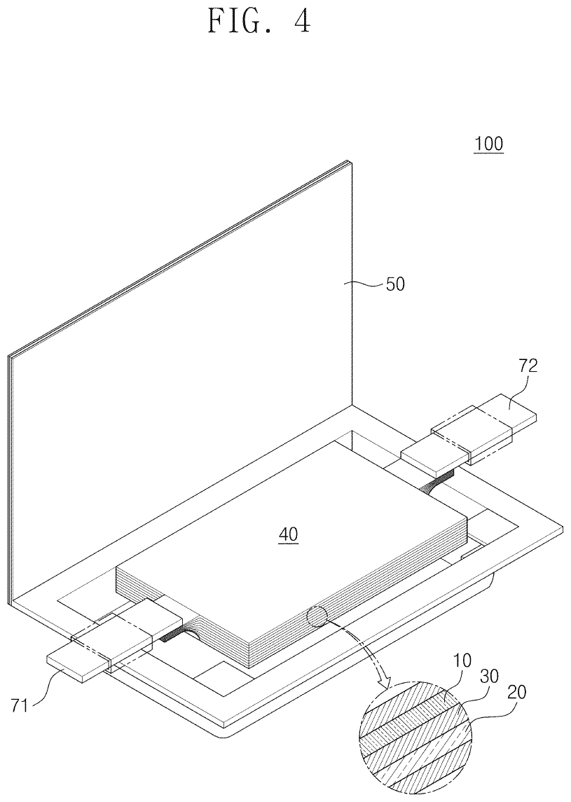

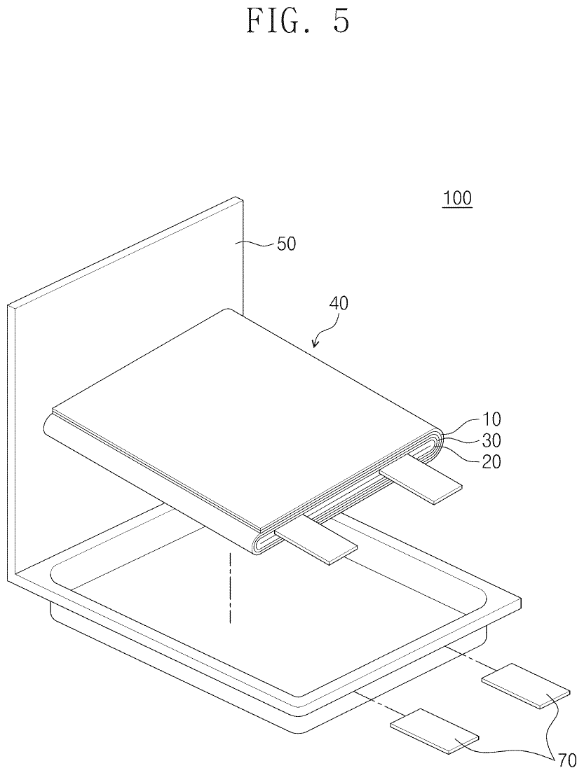

The rechargeable lithium battery may be classified into cylindrical, prismatic, pouch, or coin-type (kind) batteries, and/or the like depending on their shape. FIGS. 2 to 5 are schematic views illustrating a rechargeable lithium battery according to one or more embodiments. FIG. 2 shows a cylindrical battery, FIG. 3 shows a prismatic battery, and FIGS. 4 and 5 show pouch-type (kind) batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 sealing the case 50, as shown in FIG. 2. In FIG. 3, the rechargeable lithium battery 100 may include a positive lead tab 11, a positive terminal 12, a negative lead tab 21, and a negative terminal 22. As shown in FIGS. 4 and 5, the rechargeable lithium battery 100 may include an electrode tab(s) 70, which may be, for example, a positive electrode tab 71 and a negative electrode tab 72 serving as an electrical path for inducing the current formed in the electrode assembly 40 to the outside.

### Positive Electrode 10

The rechargeable lithium battery according to one or more embodiments may include a positive electrode. For example, the rechargeable lithium battery according to one or more embodiments may include a positive electrode including a positive electrode active material.

The positive electrode 10 for a rechargeable lithium battery may include a current collector COL1 and a positive electrode active material layer AML1 on the current collector. The positive electrode active material layer AML1 may include a positive electrode active material and may further include a binder and/or a conductive material (e.g., an electrically conductive material or electron conductor).

An amount of the positive electrode active material may be about 90 wt % to about 99.5 wt % relative to 100 wt % of the positive electrode active material layer AML1. For example, an amount of the positive electrode active material in the positive electrode active material layer AML1 may be about 92 wt % to about 99.5 wt % or about 95 wt % to about 99 wt % relative to 100 wt % of the positive electrode active material layer AML1.

The positive electrode active material may include a compound (lithiated intercalation compound) that is capable of intercalating and deintercalating lithium. For example, at least one of a composite oxide of lithium and a metal selected from among cobalt, manganese, nickel, and/or one or more (e.g., any suitable) combinations thereof may be used.

The composite oxide may be a lithium transition metal composite oxide. Non-limiting examples of the composite oxide may include lithium nickel-based oxide, lithium cobalt-based oxide, lithium manganese-based oxide, lithium iron phosphate-based compound, cobalt-free nickel-manganese-based oxide, and/or a (e.g., any suitable) combination thereof.

The positive electrode active material may include a lithium composite oxide represented by Formula 4.

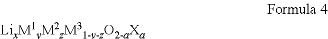

In Formula 4,
x, a, y, and z satisfy 0.5≤x≤1.8, 0≤a≤1, 0<y≤1, 0≤z≤1, and 0≤y+z≤1,
M¹, M², and M³ may each independently be at least one element selected from among the group consisting of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), and lanthanum (La), and
X may be at least one element selected from among fluorine (F), sulfur (S), phosphorus (P), and chlorine (Cl).

For example, a compound represented by any one among the following chemical formulas may be used as the lithium composite oxide: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 5≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the preceding chemical formulas, A may be Ni, Co, Mn, and/or a (e.g., any suitable) combination thereof, X may be Al, Ni, Co, Mn, Cr, Fe, Mg, Sr, V, a rare earth element, and/or a (e.g., any suitable) combination thereof, D may be O, F, S, P, and/or a (e.g., any suitable) combination thereof, G may be Al, Cr, Mn, Fe, Mg, La, Ce, Sr, V, and/or a (e.g., any suitable) combination thereof, and L¹ may be Mn, Al, and/or a (e.g., any suitable) combination thereof.

The lithium composite oxide may have a Ni content (e.g., amount) of about 50 mol % or greater with respect to 100 mol % of metals excluding lithium. For example, the lithium composite oxide may have a Ni content (e.g., amount) of about 65 mol % or greater, about 80 mol % or greater, about 85 mol % or greater, about 90 mol % or greater, about 91 mol % or greater, or about 94 mol % or greater, or about 99 mol % or greater, with respect to 100 mol % of metals excluding lithium.

The positive electrode active material may include at least one selected from among the group consisting of lithium iron phosphate (LFP), lithium manganese iron phosphate (LMFP), lithium nickel cobalt aluminum oxide (NCA), lithium nickel cobalt manganese oxide (NCM), lithium cobalt oxide (LCO), lithium manganese oxide (LMO), and lithium nickel manganese oxide (LNMO). As a non-limiting example, the positive electrode active material may include lithium cobalt oxide (LCO).

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and/or nylon, but the present disclosure is not limited thereto.

For example, the positive electrode may include a binder including at least one (e.g., one or more) of polyvinyl alcohol, carboxymethyl cellulose, hydroxypropyl cellulose, diacetyl cellulose, polyvinyl chloride, carboxylated polyvinyl chloride, polyvinyl fluoride, polyethylene oxide, polyvinylpyrrolidone, polyurethane, polytetrafluoroethylene, polyvinylidene fluoride, polyethylene, and/or polypropylene.

The binder may be present in an amount of about 0.5 wt % to about 5 wt % relative to the total weight of the positive electrode. For example, the binder may be present in an amount of about 1 wt % to about 4.5 wt % or about 1.5 wt % to about 4 wt % relative to the total weight of the positive electrode.

The conductive material may be used to provide an electrode with conductivity, and any suitable conductive material that does not cause a chemical change in a battery may be used as the conductive material. The conductive material may include, for example, a carbon-based material such as natural graphite, artificial graphite, carbon black, acetylene black, Ketjen black, carbon fiber, carbon nano-fiber, and/or carbon nano-tube; a metal powder or metal fiber containing at least one (e.g., one or more) of copper, nickel, aluminum, and/or silver; a conductive polymer such as a polyphenylene derivative; and/or a (e.g., any suitable) mixture thereof.

For example, the positive electrode may include a conductive material including a carbon-based material, a metal-based material in the form of metal powder or metal fiber, a conductive polymer, and/or a (e.g., any suitable) mixture thereof.

The conductive material may be present in an amount of about 0.5 wt % to about 5 wt % relative to the total weight of the positive electrode. For example, the positive electrode conductive material may be present in an amount of about 0.5 wt % to about 4 wt %, about 0.5 wt % to about 3.5 wt %, or about 0.5 wt % to about 2 wt % relative to the total weight of the positive electrode.

Aluminum (Al) may be used as the current collector COL1, but the present disclosure is not limited thereto.

### Negative Electrode 20

The rechargeable lithium battery according to one or more embodiments may include a negative electrode. For example, the rechargeable lithium battery according to one or more embodiments may include a negative electrode including a negative electrode active material.

The negative electrode 20 for a rechargeable lithium battery may include a current collector COL2 and a negative electrode active material layer AML2 positioned on the current collector COL2. The negative electrode active material layer AML2 may include a negative electrode active material and may further include at least one (e.g., one or more) of a binder and/or a conductor (e.g., a conductive material or an electron conductor).

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that reversibly intercalates/deintercalates lithium ions may include a carbon-based negative electrode active material, such as, for example. crystalline carbon, amorphous carbon and/or a (e.g., any suitable) combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x≤2), a Si-Q alloy (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof). The Sn-based negative electrode active material may include Sn, SnO₂, SnO_{y} (where 0<y≤2), a Sn-based alloy, and/or a (e.g., any suitable) combination thereof.

The silicon-carbon composite may be a composite of silicon and amorphous carbon. According to one or more embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The negative electrode active material in the negative electrode active material layer AML2 may be present in an amount of about 90 wt % to about 99 wt % relative to the total weight of the negative electrode active material layer AML2. For example, the negative electrode active material may be present in an amount of about 93 wt % to about 99 wt % or about 96 wt % to about 98.5 wt % relative to the total weight of the negative electrode active material layer AML2.

The negative electrode active material may include at least one selected from among graphite and a silicon composite.

When the negative electrode active material includes both (e.g., simultaneously) a silicon composite and graphite, the silicon composite and the graphite may be included in the form of a mixture, and in this case, the silicon composite and the graphite may be included in a weight ratio of about 1:99 to about 50:50. For example, a weight ratio of the silicon composite and the graphite may be about 3:97 to about 20:80 or about 5:95 to about 20:80.

The silicon composite may include a core including silicon-based particles and an amorphous carbon coating layer, and the silicon-based particle may include at least one selected from among a silicon-carbon composite, SiOₓ (where 0<x≤2), and a silicon alloy. For example, the silicon-carbon composite may include a core including silicon particles and crystalline carbon, and may also include an amorphous carbon coating layer positioned on a surface of the core.

The crystalline carbon may include graphite, for example, natural graphite, artificial graphite, and/or a (e.g., any suitable) mixture thereof.

The negative electrode may include a binder. The negative electrode binder may serve to improve attachment of negative electrode active material particles to each other and also to improve attachment of the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin(s), polyvinyl alcohol, and/or a (e.g., any suitable) combination thereof.

When an aqueous binder is used as the negative electrode binder, a cellulose-based compound capable of imparting viscosity may be further included. As the cellulose-based compound, a mixture of at least one (e.g., one or more) of carboxymethyl cellulose, hydroxypropylmethyl cellulose, methyl cellulose, and/or an alkali metal salt thereof may be used. The alkali metal salt may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, and/or a (e.g., any suitable) combination thereof.

In some embodiments, the binder may be provided in an amount of about 0.5 wt % to about 5 wt % with respect to a total weight of the negative electrode. For example, the negative electrode binder may be provided in an amount of about 0.5 wt % to about 3.5 wt % or about 0.5 wt % to about 2 wt %, with respect to a total weight of the negative electrode.

The negative electrode may include a conductive material (e.g., an electron conductor). Descriptions of the conductive material is as described herein.

The negative current collector COL2 may include a copper foil, a nickel foil, a stainless steel foil, a titanium foil, a nickel foam, a copper foam, a polymer substrate coated with a conductive metal, and/or a (e.g., any suitable) combination thereof.

### Separator 30

Depending on the type (kind) of the rechargeable lithium battery, the separator 30 may be present between the positive electrode 10 and the negative electrode 20. The separator 30 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and/or the like.

The separator 30 may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (e.g., TEFLON), or a copolymer or mixture of two or more thereof.

The organic material may include a polyvinylidene fluoride-based polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

### Electrolyte Solution ELL

The rechargeable lithium battery according to one or more embodiments may include the electrolyte solution for a rechargeable lithium battery.

Descriptions of the electrolyte solution for a rechargeable lithium battery may each independently be substantially the same as described herein.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

Hereinafter, Examples and Comparative Examples of the present disclosure will be described. However, the following Examples are presented only as example embodiments of the present disclosure, and the present disclosure is not limited by the following Examples.

### EXAMPLES

### Preparation of Additives

### Synthesis Example 1

A mixture of 1.1 millimole (mmol) of divinyl sulfone and 30 mL of acetone was added dropwise over 30 minutes to a solution in which 2 mmol of 1H-1,2,4-triazole was mixed with acetone and thoroughly stirred with 3 mmol of sodium hydrogen carbonate. Thereafter, the mixture was stirred for 4 hours at room temperature (25° C.), the precipitate was filtered, and the filtered solution was recrystallized to obtain a compound of Formula 3-1-1.

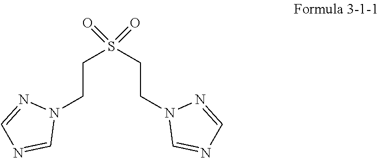 [SMILES: O=S(=O)(CCn1cncn1)CCn1cncn1]

### Preparation of Rechargeable Lithium Battery

### Example 1

### Step (Act or Task) 1: Preparation of Electrolyte Solution

1.3 molarity (M) LiPF₆ was dissolved in a non-aqueous organic solvent containing ethylene carbonate (EC), propylene carbonate (PC), and propylpropionate (PP) mixed in a volume ratio of 10:15:75, and 1 wt % of a first additive of Formula 1-1, 1 wt % of a second additive of Formula 2, and 0.5 wt % of a third additive of Formula 3-1-1 prepared in Synthesis Example 1 were added thereto to prepare an electrolyte solution.

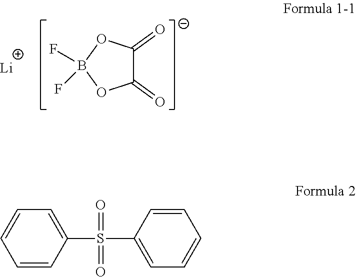

### Step (Act or Task) 2: Preparation of Rechargeable Lithium Battery

97 wt % of LiCoO₂ (LCO) as a positive electrode active material, 0.5 wt % of artificial graphite powder and 0.8 wt % of carbon black as a conductive material (e.g., electron conductor), and 0.2 wt % of acrylonitrile rubber and 1.5 wt % of polyvinylidene fluoride (PVdF) as a binder were mixed and added to N-methyl-2-pyrrolidone, and then the mixture was stirred for 30 minutes using a mechanical stirrer to prepare a positive electrode active material slurry. Using a doctor blade, the positive electrode active material slurry was applied onto a 20 micrometer ((μm)-thick aluminum current collector to be 60 μm thick, dried in a hot air dryer at 100° C. for 0.5 hours, dried again under vacuum at 120° C. for 4 hours, and then roll pressed to prepare a positive electrode.

98 wt % of a negative electrode active material in which artificial graphite and a Si composite were mixed at a weight ratio of 93:7, and 1 wt % of styrene-butadiene rubber (SBR) and 1 wt % of carboxymethyl cellulose (CMC) as a binder were mixed, and then added to distilled water, and stirred for 60 minutes using a mechanical stirrer to prepare a negative electrode active material slurry. Using a doctor blade, the negative electrode active material slurry was applied onto a 10 μm-thick copper current collector to be 60 μm thick, dried in a hot air dryer at 100° C. for 0.5 hours, dried again under vacuum at 120° C. for 4 hours, and then roll pressed to prepare a negative electrode.

An electrode assembly was prepared by assembling the positive electrode, the negative electrode, and a 10 μm-thick polyethylene separator, and the electrolyte solution prepared in step (e.g., act or task) (1) was injected to prepare a rechargeable lithium battery.

### Example 2

A rechargeable lithium battery was manufactured in substantially the same manner as in Example 1, except that the third additive from step (e.g., act or task) (1) was used in an amount of 1 wt %.

### Example 3

A rechargeable lithium battery was manufactured in substantially the same manner as in Example 1, except that the third additive from step (e.g., act or task) (1) was used in an amount of 2 wt %.

### Example 4

A rechargeable lithium battery was manufactured in substantially the same manner as in Example 1, except that the second additive and the third additive from step (e.g., act or task) (1) were used in an amount of 0.5 wt % and 1 wt %, respectively.

### Example 5

A rechargeable lithium battery was manufactured in substantially the same manner as in Example 1, except that the second additive and the third additive from step (e.g., act or task) (1) were used in an amount of 2 wt % and 1 wt %, respectively.

### Comparative Example 1

A rechargeable lithium battery was manufactured in substantially the same manner as in Example 1, except that the additives from step (e.g., act or task) (1) were not used.

### Comparative Example 2

A rechargeable lithium battery was manufactured in substantially the same manner as in Example 1, except that the first additive from step (e.g., act or task) (1) was used alone in an amount of 2 wt %.

### Comparative Example 3

A rechargeable lithium battery was manufactured in substantially the same manner as in Example 1, except that the second additive from step (e.g., act or task) (1) was used alone in an amount of 2 wt %.

### Comparative Example 4

A rechargeable lithium battery was manufactured in substantially the same manner as in Example 1, except that the third additive from step (e.g., act or task) (1) was used alone in an amount of 2 wt %.

### Comparative Example 5

A rechargeable lithium battery was manufactured in substantially the same manner as in Example 1, except that 2 wt % of a compound of Formula X was used instead of the first to third additives from step (e.g., act or task) (1).

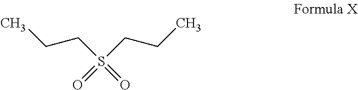

### Comparative Example 6

A rechargeable lithium battery was manufactured in substantially the same manner as in Example 1, except that 1 wt % of a compound of Formula X, and the first and second additives from step (e.g., act or task) (1), each in an amount of 1 wt %, were used.

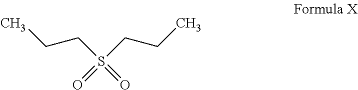

### Comparative Example 7

A rechargeable lithium battery was manufactured in substantially the same manner as in Example 1, except that the first additive and the second additive from step (e.g., act or task) (1) were used in an amount of 1 wt % and 2 wt %, respectively.

### EVALUATION EXAMPLES

### Evaluation Example 1: Evaluation of Charge/Discharge Characteristics

The rechargeable lithium batteries prepared in Examples 1 to 5 and Comparative Examples 1 to 7 were evaluated for charge/discharge characteristics.

For example, the rechargeable lithium batteries were charged at a constant current of 0.2 C rate at 25° C. up to 4.53 V (vs. Li), and the charging was cut off at 0.05 C rate while keeping the voltage of 4.3 V in a constant voltage mode. Then, the rechargeable lithium batteries were discharged at a constant current of 0.2 C rate up to 2.5 V (vs. Li) (formation process).

The rechargeable lithium battery subjected to the preceding formation process were evaluated under high temperature (45° C.) and high pressure conditions for rapid charge/discharge characteristics. To this end, the rechargeable lithium batteries was subjected to 600 charge/discharge cycles under the conditions of charge (3.0 C/4.53 V, 0.1 C cut-off, 10 minutes of rest)/discharge (0.5 C/3.0 V cut-off, 10 minutes of rest) at 45° C., and changes in retention capacity and direct current internal resistance (DC-IR) were measured. In this case, the capacity retention (%) was calculated through Equation A, and DC-IR increase rate (%) was calculated through Equation B.

$$Capacity retention = ( discharge capacity after 600 cycles ) / ( discharge capacity after 1 cycle ) \times 100 \qquad Equation A$$

$$DC - IR increase rate = ( DC - IR after 600 cycles / initial DC - IR ) \times 100 \qquad Equation B$$

### Evaluation Example 2: Evaluation of High-Temperature Gas Generation Characteristics

The rechargeable lithium batteries prepared in Examples 1 to 5 and Comparative Examples 1 to 7 were evaluated for high-temperature gas generation characteristics.

For example, the rechargeable lithium batteries were charged up to 4.53 V at 45° C. and then left in a constant temperature bath at 60° C. for 4 weeks. In this case, the thickness of each battery before and after 4 weeks was measured, and thickness increase rate (%) was calculated through Equation C to determine a gas reduction effect. In this case, the thickness of the battery was measured in a way that, using a compression-type (kind) thickness gauge from Mitutoyo, a pouch cell was placed between compression plates and compressed with a weight of 300 g.

$$Thickness increase rate = [ ( battery thickness after 4 weeks of storage - initial battery thickness ) / initial battery thickness ] \times 100 \qquad Equation C$$

TABLE 1

| | Capacity | DC-IR increase | Thickness |
|---|---|---|---|
| | retention (%) | rate (%) | increase |
| Item | after 600 cycles | after 600 cycles | rate (%) |
| Example 1 | 50 | 32 | 18 |
| Example 2 | 50 | 33 | 11 |
| Example 3 | 46 | 34 | 13 |
| Example 4 | 37 | 44 | 13 |
| Example 5 | 39 | 40 | 14 |
| Comparative | 22 | 56 | 10 |
| Example 1 | | | |
| Comparative | 30 | 47 | 26 |
| Example 2 | | | |
| Comparative | 29 | 48 | 9 |
| Example 3 | | | |
| Comparative | 19 | 53 | 6 |
| Example 4 | | | |
| Comparative | 15 | 63 | 10 |
| Example 5 | | | |
| Comparative | 36 | 48 | 22 |
| Example 6 | | | |
| Comparative | 39 | 40 | 21 |
| Example 7 | | | |

Referring to Table 1, the rechargeable lithium batteries of Examples 1 to 5 were superior to Comparative Examples 1 to 7 in rapid charge/discharge characteristics and high-temperature storage characteristics under high-temperature (45° C.) and high-pressure conditions. For example, the rechargeable lithium batteries of Examples 1 to 5 manufactured using electrolyte solutions including the first to third additives represented by Formulas 1 to 3, when subjected to rapid charge/discharge under high-temperature and high-pressure conditions, were found to exhibit excellent or suitable capacity retention and DC-IR increase rates, and excellent or suitable high-temperature storage characteristics resulting from a small change in the thickness of the batteries due to low gas generation during high-temperature storage, compared to Comparative Examples 1 to 7 with no use of one, two, or three (e.g., all) of the additives of Formulas 1 to 3.

An electrolyte solution for a rechargeable lithium battery according to one or more embodiments of the present disclosure includes first to third additives represented by Formulas 1 to 3, and thus may exhibit superior lifespan characteristics and stability even under high voltage, quick charging, and high temperature conditions when a rechargeable lithium battery including the electrolyte solution is activated.

A battery manufacturing device, a battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Descriptions of features or aspects within each embodiment should typically be considered as available for other similar features or aspects in other embodiments. A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Although one or more embodiments of the present disclosure have been described herein, the scope of the present disclosure is not limited to the one or more embodiments. One or more suitable modifications of the example embodiments may be made without departing from the spirit and scope of the disclosure as defined by the appended claims and equivalents thereof. Therefore one or more suitable modifications are included in the scope of the present disclosure.

What is claimed is:

1. An electrolyte solution comprising:
a non-aqueous organic solvent;
a lithium salt;
a first additive represented by Formula 1;
a second additive represented by Formula 2; and
a third additive represented by Formula 3: 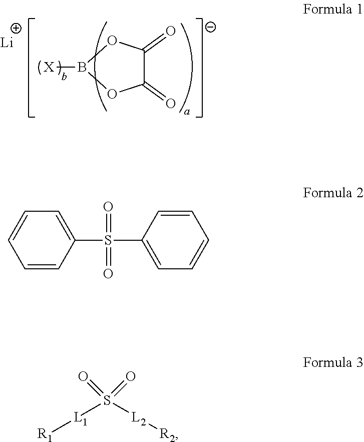
wherein in Formulas 1 to 3,
X is a halogen group or a C1 to C10 haloalkyl group,
a is 1 or 2,
if a is 1, then b is 2,
if a is 2, then b is 0,
L₁ and L₂ are each independently a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group,
R₁ and R₂ are each independently a substituted or unsubstituted C1 to C20 alkyl group, a substituted or unsubstituted C6 to C20 aryl group, or a substituted or unsubstituted C2 to C20 heteroaryl group, and
at least one of R₁ or R₂ is a group represented by Formula A: 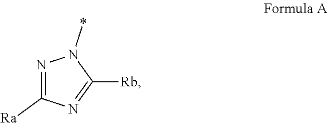
wherein in Formula A,
Rₐ and R_{b} are each independently hydrogen, a halogen group, a substituted or unsubstituted C1 to C10 alkyl group, or a substituted or unsubstituted C3 to C10 cycloalkyl group, and
wherein the electrolyte solution is an electrolyte solution for a rechargeable lithium battery.

2. The electrolyte solution as claimed in claim 1, wherein the first additive is represented by Formula 1-1 or Formula 1-2:

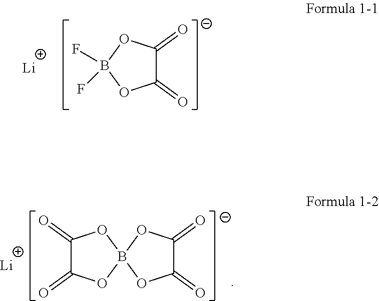

3. The electrolyte solution as claimed in claim 1, wherein at least one of L₁ or L₂ is a substituted or unsubstituted C1 to C5 alkylene group.

4. The electrolyte solution as claimed in claim 1, wherein L₁ and L₂ are each independently a substituted or unsubstituted C2 to C5 alkylene group.

5. The electrolyte solution as claimed in claim 1, wherein the third additive is represented by Formula 3-1: 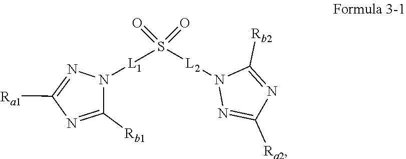
and
wherein in Formula 3-1,
L₁ and L₂ are each independently a substituted or unsubstituted C2 to C5 alkylene group, and
Rₐ₁, R_{b1}, Rₐ₂, and R_{b2} are each independently hydrogen, a halogen group, a substituted or unsubstituted C1 to C10 alkyl group, or a substituted or unsubstituted C3 to C10 cycloalkyl group.

6. The electrolyte solution as claimed in claim 1, wherein the third additive is represented by Formula 3-1-1 or Formula 3-1-2:

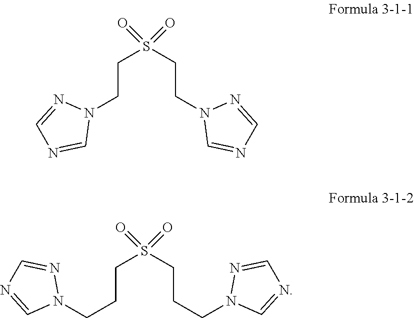 [SMILES: O=S(=O)(CCn1cncn1)CCn1cncn1 ; O=S(=O)(CCCn1cncn1)CCCn1cncn1]

7. The electrolyte solution as claimed in claim 1, comprising about 0.1 wt % to about 5 wt % of the first additive with respect to a total weight of the electrolyte solution.

8. The electrolyte solution as claimed in claim 1, comprising about 0.1 wt % to about 5 wt % of the second additive with respect to a total weight of the electrolyte solution.

9. The electrolyte solution as claimed in claim 1, comprising about 0.1 wt % to about 5 wt % of the third additive with respect to a total weight of the electrolyte solution.

10. The electrolyte solution as claimed in claim 1, wherein a weight ratio of the first additive, the second additive, and the third additive is 1:w₁:w₂,
w₁ is an amount of the second additive and is about 0.25 to about 4, and
w₂ is an amount of the third additive and is about 0.25 to about 4.

11. The electrolyte solution as claimed in claim 10, wherein a weight ratio of the second additive and the third additive (w₁:w₂) is about 1:4 to about 4:1.

12. The electrolyte solution as claimed in claim 1, wherein the lithium salt comprises at least one selected from the group consisting of LiPF₆, LiClO₄, LiBF₄, (lithium bis(fluorosulfonyl)imide (LiFSI), LiTFSI, LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LiN(SO₃C₂F₅)₂, Li(FSO₂)₂N, and LiC₄F₉SO₃.

13. The electrolyte solution as claimed in claim 1, wherein the non-aqueous organic solvent comprises at least one selected from the group consisting of ethylene carbonate (EC), propylene carbonate (PC), propylpropionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

14. The electrolyte solution as claimed in claim 1, wherein the non-aqueous organic solvent comprises ethylene carbonate (EC), propylene carbonate (PC), and propylpropionate (PP).

15. The electrolyte solution as claimed in claim 14, wherein a volume ratio of the ethylene carbonate (EC), propylene carbonate (PC), the propylpropionate (PP) is 1:a:b,
a is an amount of propylene carbonate (PC) and is about 0.5 to about 3, and
b is an amount of propylpropionate (PP) and is about 2 to about 10.

16. A rechargeable lithium battery comprising:
a positive electrode comprising a positive electrode active material;
a negative electrode comprising a negative electrode active material; and
the electrolyte solution as claimed in claim 1.

17. The rechargeable lithium battery as claimed in claim 16, wherein the positive electrode active material comprises lithium cobalt-based oxide, lithium nickel-based oxide, lithium manganese-based oxide, a lithium iron phosphate-based compound, cobalt-free nickel-manganese oxide, or a combination thereof.

18. The rechargeable lithium battery as claimed in claim 16, wherein the positive electrode active material comprises lithium cobalt oxide (LCO).

19. The rechargeable lithium battery as claimed in claim 16, wherein the rechargeable lithium battery has a driving voltage of at least about 4.0 V.

20. The rechargeable lithium battery as claimed in claim 16, wherein the rechargeable lithium battery is a cylindrical battery, a prismatic battery, a pouch-type battery, or a coin-type battery.
